(19) United States
(12) Patent Application Publication
(10) Pub. No.: US 2016/0227279 A1
(43) Pub. Date: Aug. 4, 2016

(54) Custom Media Channels

(71) Applicant: Microsoft Technology Licensing, LLC, Redmond, WA (US)

(72) Inventors: Nicholas J. Fang, Redmond, WA (US); William Brandon Blazer, Redmond, WA (US); Blake Carlton Farmer, Seattle, WA (US); Thomas A. Langan, Seattle, WA (US); Andrew Thomas Rich, Redmond, WA (US); Ashley C. Speicher, Redmond, WA (US)

(21) Appl. No.: 14/610,112

(22) Filed: Jan. 30, 2015

(51) Int. Cl. H04N 21/458; H04N 21/4627; H04N 21/45; H04N 21/482; H04N 21/475

(52) U.S. Cl. CPC H04N 21/458; H04N 21/4821; H04N 21/4826; H04N 21/4755; H04N 21/4532; H04N 21/4627

(57) ABSTRACT

A user-specified custom channel includes media content programs having any number of respective program sources. The custom channel has an associated lineup that defines the date/time at which individual media content programs are available via the custom channel. A custom channel may be represented in an electronic program guide, and a custom channel may be published by the user that created the custom channel to make the custom channel available to other users.

### BACKGROUND

Media content is available via a variety of sources, including, for example, cable or satellite television networks or cloud-based services. In addition to commercially produced broadcast and on-demand content, several cloud-based services allow users to upload user-created content. Many entertainment systems provide electronic program guides (EPGs) that allow users to browse and in some instances, interactively select, commercially available programs in which they are interested. However, with the ever-increasing amount of available media content and the ever-increasing number of sources for accessing media content, finding a program of interest can be a daunting task. In particular, if a user has a limited amount of time to enjoy media content, say 30 minutes before needing to go to an appointment, searching through hundreds of channels in an EPG or searching various on-demand services to find media content of interest can easily consume a significant amount of the time that the user has available.

### SUMMARY

Custom media channels are described herein. A user may define a custom channel to include any number of media programs available through any number of respective program sources. The custom channel is defined with a lineup to specify dates/times at which individual programs are available through the custom channel. A custom channel may be created and viewed by a user, or a user may choose to publish a custom channel the user has created, thereby making the custom channel available to other users.

### BRIEF DESCRIPTION OF THE DRAWINGS

The same numbers are used throughout the drawings to reference like features and components.

FIG. 1 is a pictorial diagram of an example environment for implementing custom media channels.

FIG. 2 is a block diagram of select data elements associated with an example custom media channel.

FIG. 3 is a pictorial diagram of an example channel lineup of an example custom media channel.

FIG. 4 is a block diagram of selected components of an example client device.

FIG. 5 is a block diagram of selected components of an example server computer system.

FIG. 6 is a flow diagram of an example method for creating a custom media channel.

FIG. 7 is a flow diagram of an example method for rendering and displaying an electronic program guide that includes custom media channels.

FIG. 8 is a flow diagram of an example method for accessing media content through a custom media channel.

FIG. 9 is a flow diagram of an example method for accessing a custom media channel published by another user.

FIG. 10 is a flow diagram of an example method for deleting a custom media channel.

### DETAILED DESCRIPTION

The following discussion is directed to custom media channels. A custom channel can be created by a user to include media content from any number of different program sources. Media content on the custom channel is presented according to a lineup, which may be user-specified or determined by the system. A custom channel can be created to include, for example, a user's favorite programming or programming focused on a particular user interest. A user may choose to publish the custom channel, thereby making the custom channel available to other users with access to the custom channel system. A user of the custom channel system may select, for inclusion in the user's electronic program guide, any number of custom channels created by the user or created and published by other users. In an example implementation, promoted custom channels may also be created, for example, by a system administrator, to highlight, for example, new or particularly interesting content aggregated from multiple program sources.

Custom media channels as described herein provide an improved user experience by presenting selected programs on a single channel, thereby enabling users to quickly access media content of interest without having to search through multiple channels. The custom media channels also include a custom lineup, which further minimizes user input by providing, at any particular time, a particular program. This is in contrast to, for example, an on-demand channel for which a user would have to not only select the channel, but then also search through and select a particular program. Reduced user interaction can also result in reduced resource usage.

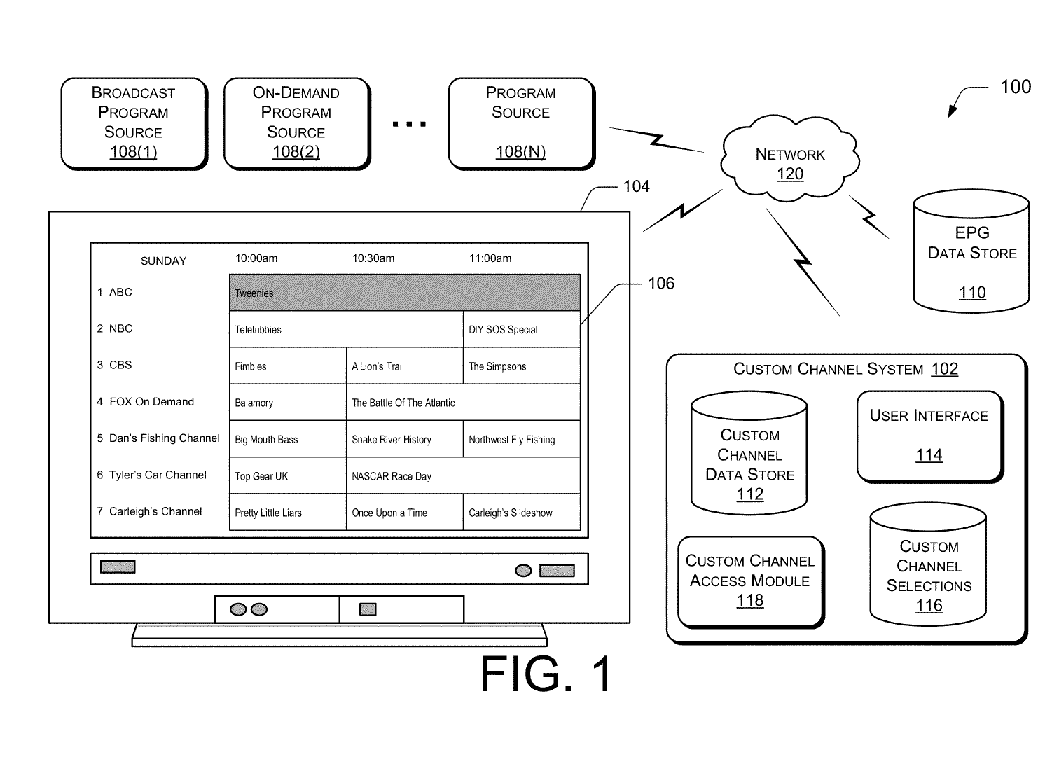

FIG. 1 illustrates an example environment 100 in which a custom channel system 102 may be implemented. In the illustrated example, a client device 104 enables a user to access an electronic program guide 106 and media content (not shown). Client device 104 represents any type of device that can receive and present media content. Client device 104 may be implemented as, for example, but without limitation, an Internet-enabled television, a television set-top box, a game console, a desktop computer, a laptop computer, a tablet computer, or a smartphone. Client device 104 receives media content from any number of program sources including, for example, broadcast program source 108(1), on-demand program source 108(2), or any number of other program sources 108(N). Program sources 108 may include program sources that allow free access to media content, such as broadcast television networks, and program sources that require payment through, for example, a subscription service. Program sources that require payment may include, for example, cable or satellite television services and cloud-based on-demand services. Program sources that require a subscription or other type of credentials are referred to herein as “limited access program sources.” The media content provided may include any combination of video, audio, images, interactive games, and so on.

As used herein, the term “commercial media content” is used to distinguish from user-generated content. Commercial media content refers to, for example, television programs, movies, music, and games that are professionally produced and made available to the public. Metadata associated with commercial media content available through free or paid-for program sources (e.g., broadcast television, cable or satellite television, subscription on-demand services, etc.) is stored in EPG data store 110. When a user requests to view an electronic program guide, data is retrieved from EPG data store 110 to populate the EPG 106 that is displayed.

Custom channel system 102 includes custom channel data store 112, user interface 114, custom channel selections 116, and custom channel access module 118. Custom channel data store 112 maintains metadata associated with user-created custom channels. In an example implementation, custom channel data store 112 also maintains various metrics associated with the custom channels. For example, users who subscribe to a custom channel can ‘like’ or rate individual programs and the custom channel system can track which programs are viewed by which users. These metrics are maintined in the custom channel data store 112. Channel creators can access the metrics associated with the channels they have created to determine how popular their custom channels are. Similarly, the custom channel system 102 can access the metrics to, for example, aid users in discovering popular content. User interface 114 provides a mechanism through which a user can create a custom channel, publish the custom channel, and select one or more custom channels for inclusion in the user's EPG 104. Custom channel selections 116 maintains a list of custom channels that a particular user has selected for inclusion in EPG 106. Custom channel access module 118 facilitates access to various program sources, which may be associated with a particular custom channel. For example, if a particular program on a custom channel is available through a subscription program source that a user does not subscribe to, custom channel access module 118 can direct the user to a service associated with the subscription program source to enable to user to purchase a subscription.

In an example implementation, custom channel system 102 also supports promoted custom channels. For example, a system administrator associated with the custom channel system 102 creates a promoted custom channel that includes programs aggregated from multiple program sources 108. In this example, program sources may pay to have a particular program included in the promoted channel. For example, a promoted channel may include episodes from multiple new television series. As another example, a promoted channel may include previews, reviews, trailers, etc. associated with an interactive game that is soon to be released. Promoted channels are published in the same way user-created custom channels are published, and are therefore available for access by other users.

Network 120 facilitates communication between client device 104, program source(s) 108, EPG data store 110 and custom channel system 102. Network 120 can include a cable television network, RF, microwave, satellite, and/or data network, such as the Internet, and may also support wired or wireless media using any format and/or protocol, such as broadcast, unicast, or multicast. Additionally, network 120 can be any type of network, using any type of network topology and any network communication protocol, and can be represented or otherwise implemented as a combination of two or more networks.

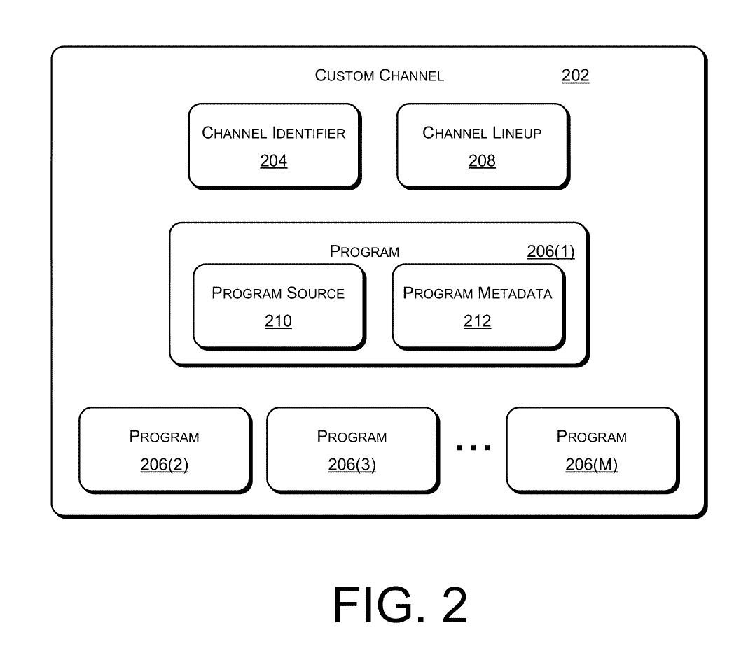

FIG. 2 illustrates example data defining a custom channel 202 that can be stored in custom channel data store 112. For each custom channel 202 that is created by a user, custom channel data store 112 maintains a channel identifier 204, one or more programs 206 (e.g., program 206(1), program 206(2), program 206(3), . . . , program 206(M)), and a channel lineup 208. For each program, the custom channel data store 112 also maintains additional information. For example, as illustrated, for program 206(1), custom channel data store 112 maintains a program source 210 and program metadata 212. Program source 210 may indicate any source from which a program is available, such as, for example, program sources 108 described above with reference to FIG. 1.

Channel identifier 204 may include, for example, one or more of a channel ID, a channel name, and/or representative image. In an example implementation, a channel ID is a unique identifier assigned to the channel by the custom channel system, while the channel name and the representative image are optional, and may be specified by a user. In various implementations, any of the channel ID, channel name, and representative image may be user-specified or automatically generated and/or assigned by the system.

Each program 206 may represent commercial media content or user-generated content. If a particular program represents commercial media content, then the program metadata 212 may be similar to program metadata associated with the program in EPG data store 110. Program metadata 212 may include, but is not limited to, for example, a program name, a program description, a genre indicator, a list of actors or artists, a year in which the program was released, and so on. Program metadata 212 may also include, for example, a description or review of the program, which may be submitted by the user that created the custom channel 202. Program source 210 indicates a source from which the program is available. If the program source 210 is a limited access program source, (e.g., the program source is a pay-per view service, subscription service, or otherwise requires login credentials), then program metadata 212 may also include a link or other information to enable a user to subscribe to, or otherwise connect with, program source 210.

If a particular program 206 is associated with a television series, the user creating the custom channel 202 may indicate that the program represents a particular episode, a selection of episodes (e.g., a particular season), or the entire series. In an example implementation, if the program represents the entire series, when that program is played through the custom channel, the episode that this played is the most recent available episode. In another example implementation, if the program represents the entire series, when the program is added to the channel lineup 208, each available episode is added to the channel lineup 208.

Channel lineup 208 associates a date and time with each program 206. When custom channel 202 is included in a user's EPG display, each program 206 is indicated in the EPG display according to the dates and time indicated in the channel lineup 208.

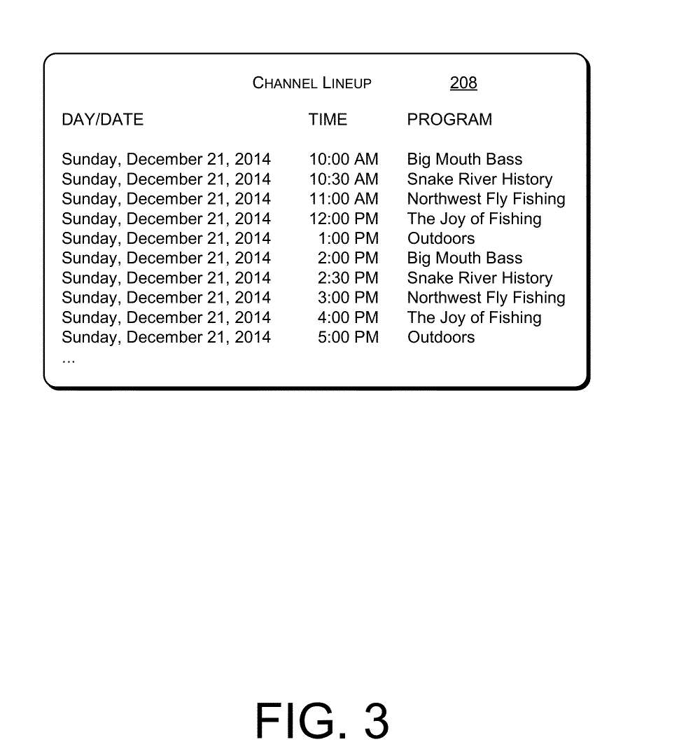

FIG. 3 illustrates a portion of an example channel lineup 208. The illustrated example corresponds to “Dan's Fishing Channel” shown in EPG 106 in FIG. 1. As shown, the channel lineup 208 includes multiple entries, each indicating a day/date, a time, and a program. In example implementations, when a user creates a custom channel (e.g., custom channel 202), the corresponding channel lineup (e.g., channel lineup 208) may be user-specified, automatically generated, or a combination. For example, a user may fully specify a channel lineup by assigning a program to each time slot for each date for an entire week, and then indicate that the same weekly lineup is to be repeated each week. As another example, the system may automatically generate a channel lineup by randomly assigning programs associated with the channel to various timeslots. As yet another example, a user may partially specify a channel lineup, by, for example, assigning programs to a few specific timeslots (e.g., each weeknight between 6:00 PM and 10:00 PM), and allowing the system to automatically assign programs to the remaining timeslots. In an example implementation, media content that is available through a broadcast program source (e.g., a broadcast television network) is automatically assigned dates and times in the channel lineup that correspond to scheduled broadcast dates and times of the program through the broadcast program source.

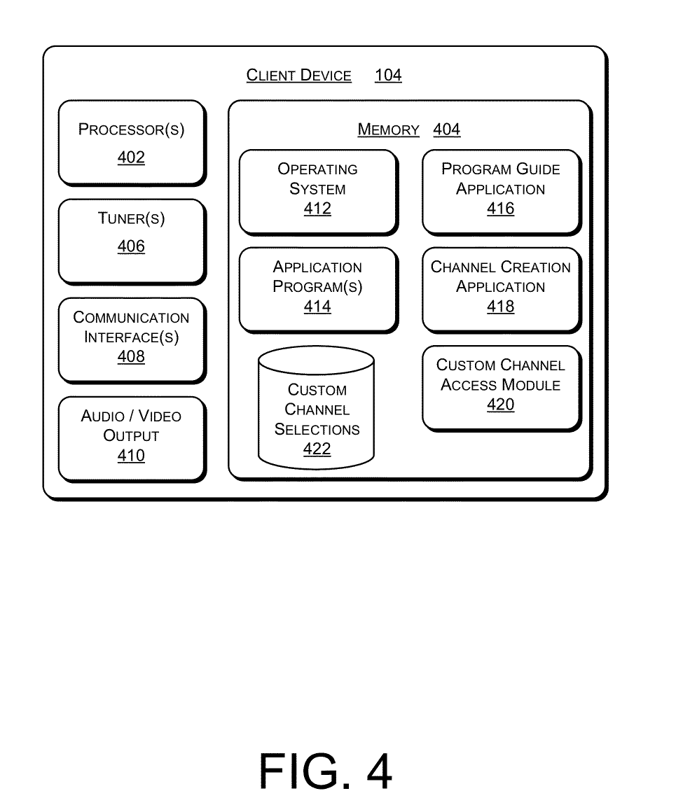

FIG. 4 illustrates select components of an example client device 104. In the illustrated example, client device 104 includes one or more processor(s) 402, a memory 404, tuner(s) 406, communication interface(s) 408, and audio/video output 410. Memory 404 may be implemented as any combination of various types of memory components. Examples of possible memory components include a random access memory (RAM), a disk drive, a mass storage component, and a non-volatile memory (e.g., ROM, Flash, EPROM, EEPROM, etc.). Alternative implementations of client device 104 can include a range of processing and memory capabilities. For example, full-resource clients can be implemented with substantial memory and processing resources, including a disk drive to store content for replay by the viewer. Low-resource clients, however, may have limited processing and memory capabilities, such as a limited amount of RAM, no disk drive, and limited processing capabilities.

Processor(s) 402 process various instructions to control the operation of client device 104 and to communicate with other electronic and computing devices. The memory 404 stores various information and/or data such as content, EPG data, configuration information for client device 104, and/or graphical user interface information.

Tuner(s) 406 are representative of one or more in-band tuners that tune to various frequencies or channels to receive television signals, as well as an out-of-band tuner that tunes to a channel over which the EPG data is transmitted to client device 104. Tuner(s) 406 may also be representative of any other means with which media content may be received. For example, in an environment that supports transmission of media content over an IP network, tuner 406 may represent an Internet browser configured to receive media content via a particular universal resource locator (URL).

Communication interface(s) 408 enable client device 104 to communicate with other computing devices. Audio/Video output 410 includes, for example, a display screen and speakers, enabling client device 104 to present various forms of media content. In example implementations, audio/video output 410 provides signals to a television or other device that processes and/or presents or otherwise renders the audio and video data.

An operating system 412, one or more application programs 414, a program guide application 416, a channel creation application 418, and a custom channel access module 420 are stored in memory 404 and executed on processor 402. The application programs 414 that can be implemented at client device 104 can include, for example, a browser to browse the Internet, an email program to facilitate electronic mail, and so on. Program guide application 416 receives and processes EPG data to generate an EPG grid.

Channel creation application 418 enables a user to create a custom channel, identify programs for inclusion in the custom channel and create a timeline for the custom channel. Channel creation application 418 also enables a user to publish a custom channel that the user has created and to select one or more custom channels that have been created and published by other users. In an example implementation, channel creation application 418 corresponds to at least a portion of the custom channel system 102 illustrated in FIG. 1, including, for example, user interface 114. Although illustrated as residing in memory 404 of client device 104, all or part of channel creation application 418 may be executed on a server and accessed via client device 104, for example, through a cloud-based service.

Custom channel access module 420 facilitates access to various program sources while a user is accessing media content through a custom channel. As described above with reference to FIG. 1, custom channel access module can connect a user to a service associated with a subscription program source in an event that the user is attempting to access media content from the subscription program source but doesn't have a valid subscription to the program source.

Memory 404 also includes custom channel selections 422, which maintains a list of custom channels that a user has created or to which a user has subscribed. For example, custom channel selections 422 may include identifiers associated with any number of custom channels created by a user of client device 104 and may also include identifiers associated with any number of custom channels that were created and published by other users and in which the user of client device 104 has expressed an interest.

Client device 104 can also include other components pertaining to a television entertainment system which are not illustrated in this example for simplicity purposes. For instance, client device 104 can include a user interface application and user interface lights, buttons, controls, etc. to facilitate viewer interaction with the device.

Although shown separately, some of the components of client device 104 may be implemented in an application specific integrated circuit (ASIC). Additionally, a system bus (not shown) typically connects the various components within client device 104. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

General reference is made herein to one or more client devices, such as client device 104. As used herein, “client device” means any electronic device having data communications, data storage capabilities, and/or functions to process signals, such as broadcast signals, received from any of a number of different sources. In one implementation, functionality of the client device may be distributed such that one device, for example a personal computer, renders the EPG grid, including listings for custom channels, and communicates with a set-top box that receives and processes broadcast signals.

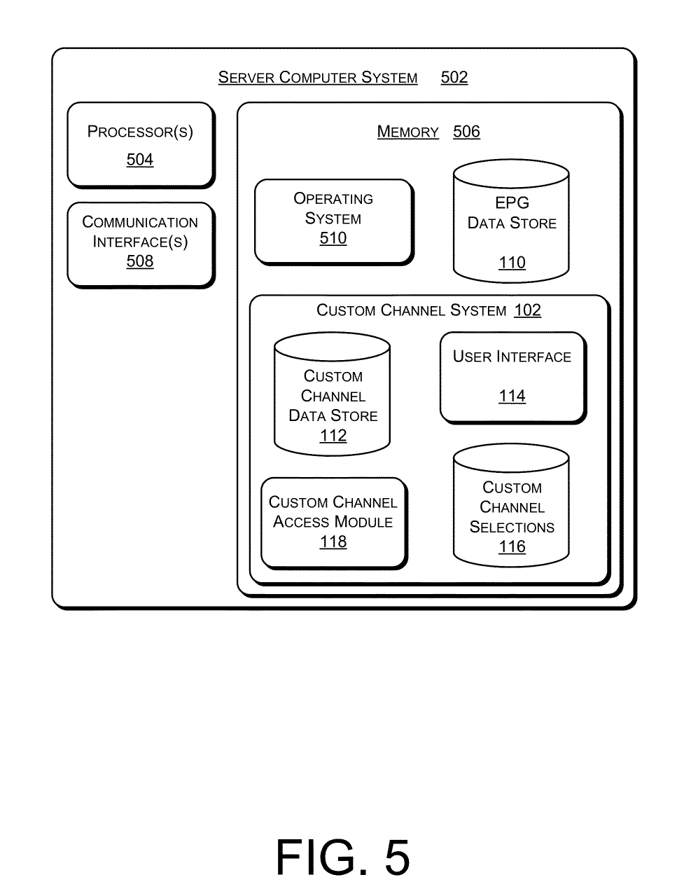

FIG. 5 illustrates select components of an example server computer system 502 that provides all or part of the custom channel system 102 as a cloud-based service. In the illustrated example, server computer system 502 includes one or more processor(s) 504, a memory 506, and one or more communication interface(s) 508. Communication interface(s) 508 enable server computer system 502 to communication with any number of other computer systems.

An operating system 510 and a custom channel system 102 are maintained in memory 506 and executed on the processor(s) 504. In an example implementation, server computer system 502 may also maintain EPG data store 110. In various implementations, EPG data store 110 and one or more components of custom channel system 102 may be distributed across any number of server computer systems or client devices. As described above with reference to FIG. 1, custom channel system 102 includes custom channel data store 112, user interface 114, custom channel selections 116, and custom channel access module 118.

Alternatively, or in addition, the functionality of the custom channel system described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Any of the components illustrated in FIG. 4 or FIG. 5 may be implemented using any form of computer-readable media that is accessible by computing device 104 or server computer system 502, either locally or remotely, including over a network. Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

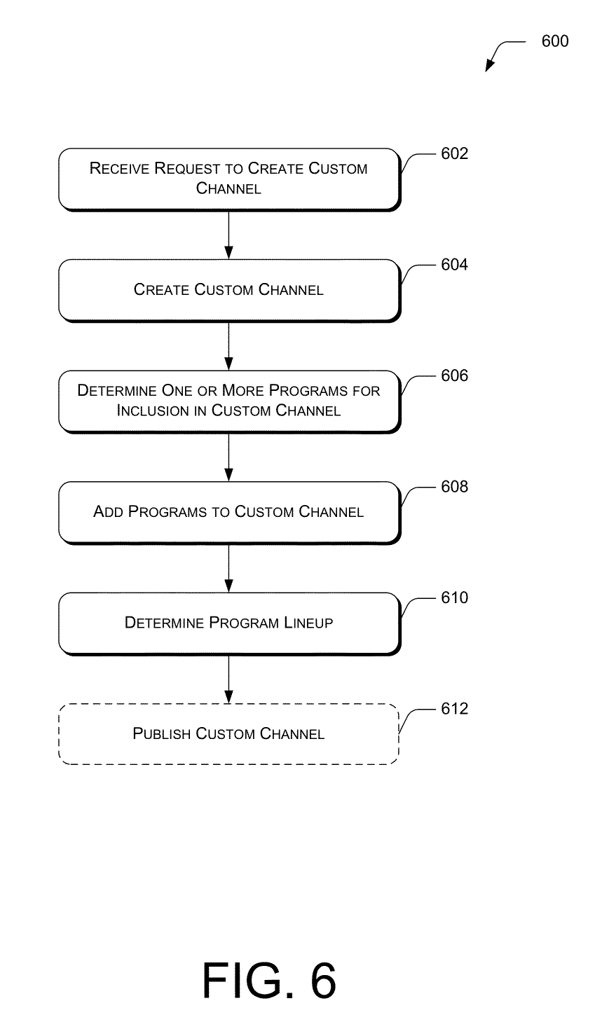

FIG. 6 illustrates an example process 600 for creating a custom channel. The process is illustrated as a set of operations shown as discrete blocks. The process may be implemented in any suitable hardware, software, firmware, or combination thereof. The order in which the operations are described is not to be construed as a limitation.

At block 602, custom channel system 102 receives a request to create a custom channel. For example, a user accesses user interface 114 and submits a request to create a new custom channel.

At block 604, custom channel system 102 creates the requested custom channel. For example, custom channel system 102 creates a new record in custom channel data store 112 having at least a channel identifier 204.

At block 606, custom channel system 102 determines one or more programs for inclusion in the custom channel. For example, using user interface 114, a user may identify one or more programs to be included in the custom channel. As described above, the programs that are identified can be associated with any number of different program sources including, but not limited to, free or subscription broadcast or on-demand services. In an example implementation, if a user indicates a particular series of programs (e.g., a television series, a webcast series, etc.) the user may indicate a particular episode of the series, or may indicate that all (or a particular subset) of episodes are to be included in the custom channel.

At block 608, custom channel system 102 adds the determined programs to the custom channel. For example, data identifying the determined programs is added to the custom channel data store 112. The added data can include, for example, a program source 210 and program metadata 212.

At block 610, custom channel system 102 determines a program lineup for the requested custom channel. For example, as described above, a user may specify all or part of a lineup through the user interface 114 and/or the custom channel system 102 may automatically generate all or part of a lineup.

At block 612, a user may optionally choose to publish the custom channel that has been created. For example, the requested custom channel is stored in custom channel data store 112 for access by the user who created the custom channel. If the user chooses to publish the custom channel, for example, via a command through the user interface 114, the custom channel system then makes the custom channel in custom channel data store 112 available to other users of the custom channel system 102.

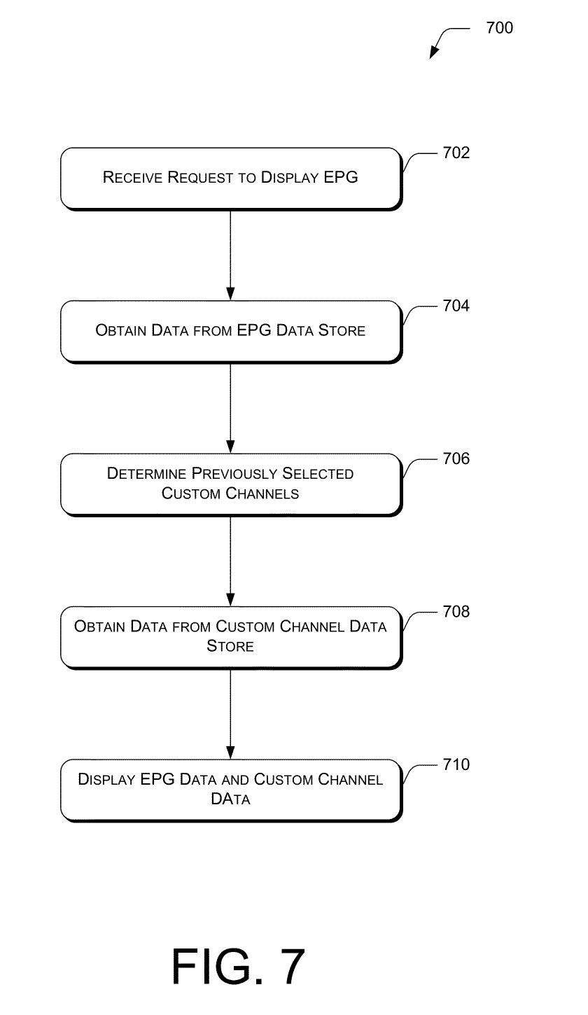

FIG. 7 illustrates an example process 700 for rendering an electronic program guide that includes listings for custom channels. The process is illustrated as a set of operations shown as discrete blocks. The process may be implemented in any suitable hardware, software, firmware, or combination thereof. The order in which the operations are described is not to be construed as a limitation.

At block 702, program guide application 416 receives a request to display an EPG For example, using a remote control or other input device, a user submits a command to client device 104 signaling a request to view a program guide.

At block 704, program guide application 416 obtains data from EPG data store 110. For example, as described above with reference to FIG. 1, metadata associated with commercially produced media content that is available to the user via free or subscription-based program sources (e.g., cable television or cloud-based on-demand services) is stored in EPG data store 110. This metadata identifies channels, programs, and lineups for media content available through these various program sources.

At block 706, program guide application 416 determines previously selected custom channels. For example, program guide application 416 accesses custom channel selections 422 or custom channel selections 116 to identify custom channels that have been created by the user or that have been created and published by other users and selected for viewing by the current user.

At block 708, program guide application 416 obtains data from custom channel data store 112. For example, program guide application 416 requests program metadata from custom channel data store 112 for custom channels identified at block 706.

At block 710, program guide application 416 renders an electronic program guide for display that includes both the EPG data obtained from the EPG data store 110 and the custom channel data obtained from the custom channel data store 112.

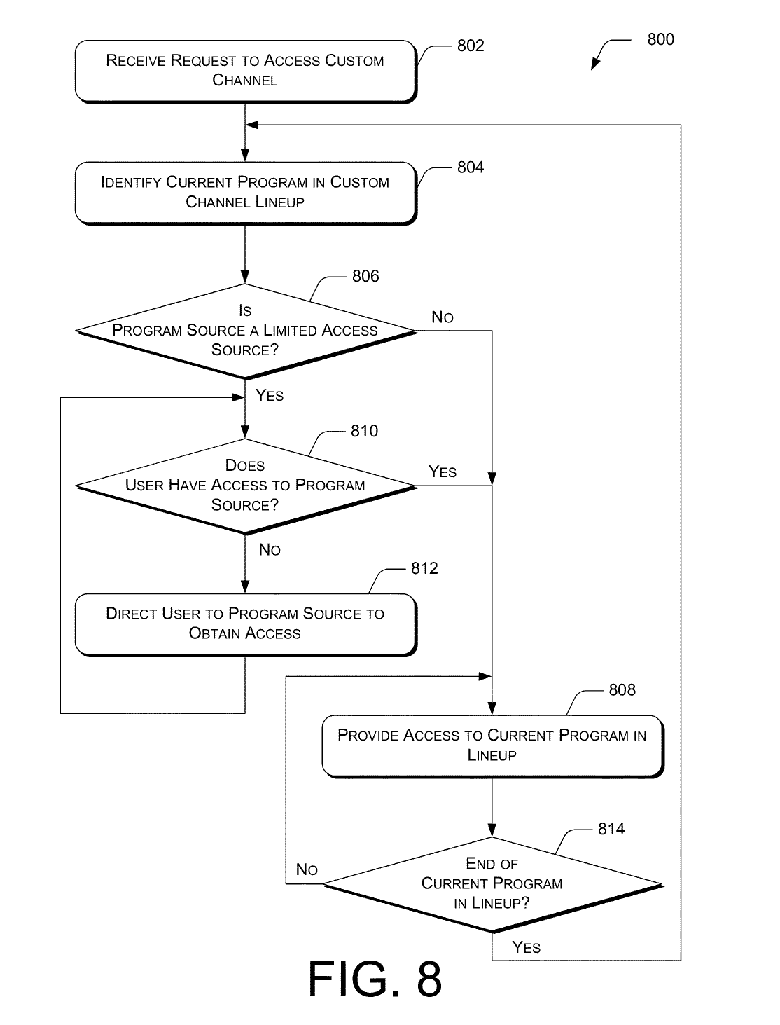

FIG. 8 illustrates an example process 800 for accessing media content through a custom channel. The process is illustrated as a set of operations shown as discrete blocks. The process may be implemented in any suitable hardware, software, firmware, or combination thereof. The order in which the operations are described is not to be construed as a limitation.

At block 802, client device 104 receives a request to access a custom channel. For example, a user submits a command via a remote control or other input device to select a custom channel displayed in the EPG display 106. In an example implementation, custom channel access module 420 receives the command.

At block 804, custom channel system 102 identifies a current program in the selected custom channel lineup. For example, based on the example illustrated in FIG. 1, if the command is to select the custom channel named “Dan's Fishing Channel,” and the command is received at 10:15 AM, the custom channel system 102 will identify “Big Mouth Bass” as the current program in the selected channel's lineup.

At block 806, the custom channel system 102 determines whether or not a program source associated with the identified current program is a limited access source. For example, custom channel access module 420 identifies the program source 210 associated with the current program. If the program source 210 does not require a subscription and does not implemented any other sort of limited access (the “No” branch from block 806), then at block 808, client device 104 accesses the program source associated with the identified current program, and begins presenting the identified current program.

On the other hand, if the program source 210 requires a subscription or implements some other sort of limited access (the “Yes” branch from block 806), then at block 810, custom channel system 102 determines whether or not the user has access to the program source associated with the current channel. For example, custom channel access module 420 may maintain a list of credentials associated with any number of limited access program sources to which the user has access. If custom channel access module 420 is unable to determine that the user has access to the limited access program source associated with the current program in the selected channel lineup (the “No” branch from block 810), at block 812, custom channel access module 420 directs the user to a login site associated with the limited access program source. Alternatively, the custom channel access module 420 may request user-submitted credentials to access the limited access program source rather than directing the user to a login site associated with the limited access program source. In an example implementation, when a user submits login credentials through the custom channel access module 420, custom channel access module 420 maintains those credentials for future access to the same limited access program source.

If, at block 810, custom channel access module 420 determines that the user has access to the limited access program source (the “Yes” branch from block 810), then, as described above with reference to block 808, client device 104 provides access to the current program in the lineup of the selected custom channel.

At block 814, custom channel system 102 determines whether or not the end of the current program has been reached. Custom channel system 102 may determine the end of a program based, for example, on a current time or based on an end of program indicator embedded in the media content. If the end of the current program has not been reached (the “No” branch from block 814), then processing continues as described above with reference to block 808. If the end of the current program has been reached (the “Yes” branch from block 814), then processing continues as described above with reference to block 804.

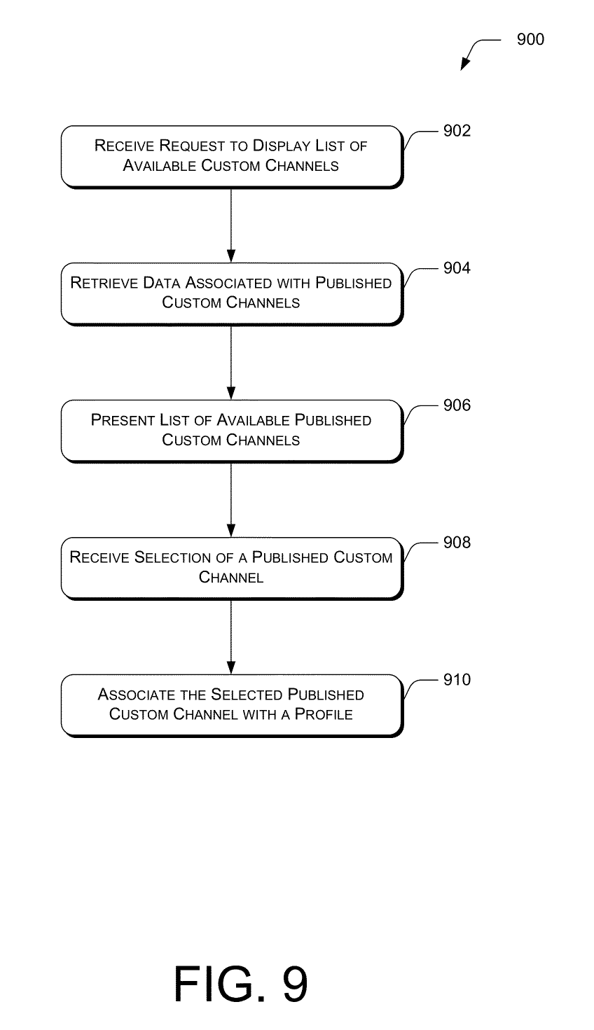

FIG. 9 illustrates an example process 900 for accessing a custom channel that was created and published by another user. The process is illustrated as a set of operations shown as discrete blocks. The process may be implemented in any suitable hardware, software, firmware, or combination thereof. The order in which the operations are described is not to be construed as a limitation.

At block 902, custom channel system 102 receives a request to display a list of available custom channels. For example, a user may submit a command through user interface 114, requesting that custom channels created and published by other users be displayed. In another example, the user may submit a search command through user interface 114, indicating search criteria to be used to identify custom channels that have been created and published by other users.

At block 904, custom channel system 102 retrieves data associated with published custom channels. For example, in response to the user-submitted request or user-submitted search command, user interface 114 requests data from custom channel data store 112.

At block 906, custom channel system 102 presents a list of available published custom channels. In an example implementation, the list includes custom channels that have been created by the user and custom channels that have been created and published by other users. In some implementations, when a user publishes a custom channel, the user can specify criteria for other users to access the custom channel. For example, the user may limit the publication of the custom channel to access by only specific users (e.g., the user's family and friends). In an example implementation, the custom channel system 102 presents a list of available published custom channels, including in the list only those published channels that the user is authorized to access. In an example implementation, the list of available published custom channels may be limited based, at least in part, on user-submitted search criteria.

At block 908, custom channel system 102 receives a selection of a particular published custom channel in the list of available published custom channels. For example, a user may submit a command through user interface 114, selecting a particular custom channel.

At block 910, custom channel system 102 associates the selected published custom channel with a profile, such as a user profile. For example, data is added to custom channel selections 116 to identify the selected channel as a custom channel that the user has selected.

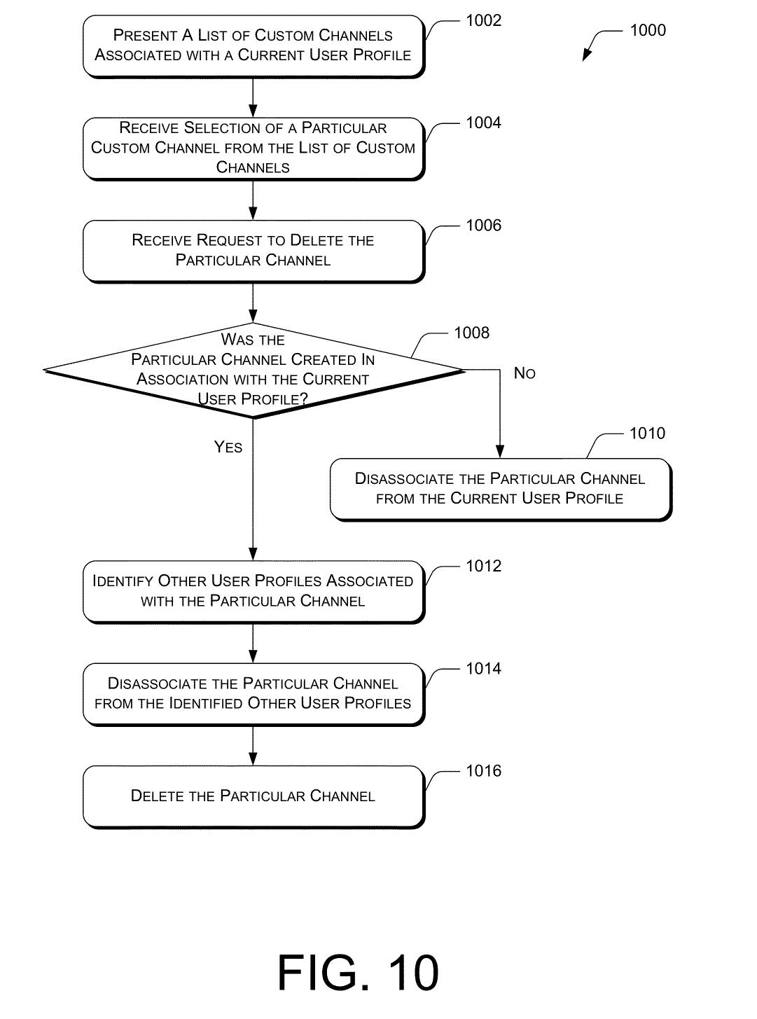

FIG. 10 illustrates an example process 1000 for deleting a custom channel. A custom channel may be deleted from a particular user's profile, or a custom channel may be deleted by the creator of the custom channel, thereby deleting the custom channel from any user profiles that have subscribed to the custom channel. The process is illustrated as a set of operations shown as discrete blocks. The process may be implemented in any suitable hardware, software, firmware, or combination thereof. The order in which the operations are described is not to be construed as a limitation.

At block 1002, custom channel system 102 presents a list of available custom channels associated with a current user profile. For example, the list can include custom channels created by a user associated with the user profile and custom channels the user has subscribed to, but that have been created and published by other users.

At block 1004, custom channel system 102 receives selection of a particular channel from the list of custom channels. For example, the user may interact with user interface 114 to indicate selection of a particular channel.

At block 1006, custom channel system 102 receives a request to delete the particular channel. For example the user may interact with user interface 114 to submit a delete command while the particular channel is selected.

At block 1008, custom channel system 102 determines whether the particular channel was created in association with the current user profile. For example, custom channel system 102 examines data in custom channel data store 112 to determine the creator of the particular channel.

If the particular channel was created and published in association with a different user profile (e.g., the current user profile is a subscriber to the particular custom channel, which was created and published by a different user) (the “No” branch from block 1008), then at block 1010, custom channel system 102 disassociates the particular channel from the current user profile. In other words, the user is unsubscribed to the custom channel, which was created and published by another user.

On the other hand, if the particular channel was created in associating with the current user profile (the “Yes” branch from block 1008), then at block 1012, the custom channel system 102 identifies any number of other user profiles associated with the particular channel. For example, custom channel system 102 examines data in custom channel selections data store 116 to identify any other users who have subscribed to the particular channel.

At block 1014, custom channel system 102 disassociates the particular channel from the identified other user profiles. For example, custom channel system 102 updates data in custom channel selections data store 116 to effectively unsub scribe the identified other user profiles from the particular channel.

At block 1016, custom channel system 102 deletes the particular channel. For example, custom channel system 102 updates data in custom channel data store 112 to remove the particular channel.

### Example Clauses

Paragraph A: A custom channel device comprising: a processor; a memory; a user interface stored in the memory and executed on the processor to enable creation of a custom channel comprising a plurality of programs; a custom channel data store for maintaining: program data associated with the plurality of programs of the custom channel; and a lineup that associates a particular date and time with a particular program such that when the custom channel is accessed at the particular date and time, the particular program is presented; and a custom channel access module stored in the memory and executed on the processor to facilitate access to respective program sources associated with the plurality of programs.

Paragraph B: A custom channel device as Paragraph A recites, wherein: a first program of the plurality of programs has associated therewith a first program source; a second program of the plurality of programs has associated therewith a second program source; the first program source is different from the second program source; the custom channel access module accesses the first program source at a date and time associated with the first program in the lineup; and the custom channel access module accesses the second program source at a date and time associated with the second program in the lineup.

Paragraph C: A custom channel device as either Paragraph A or Paragraph B recites, further comprising a custom channel selections data store to maintain a list of custom channels accessible through a particular profile.

Paragraph D: A custom channel device as Paragraph C recites, wherein the list of custom channels accessible through the particular profile comprises: a custom channel created in association with the particular profile; and a custom channel created and published in association with another profile.

Paragraph E: A method comprising: receiving a request to create a custom channel; in response to the receiving: determining a plurality of programs to include in the custom channel, each program of the plurality of programs having a respective program source such that: a first program of the plurality of programs is associated with a first program source; a second program of the plurality of programs is associated with a second program source; and the second program source is different from the first program source; and determining a lineup for the custom channel that specifies, for individual ones of the plurality of programs, a presentation time.

Paragraph F: A method as Paragraph E recites, wherein: a first program of the plurality of programs comprises commercially produced media content; and a second program of the plurality of programs comprises user-created media content.

Paragraph G: A method as Paragraph E or Paragraph F recites, wherein determining a plurality of programs to include in the custom channel comprises receiving an indication of a particular program to include in the custom channel.

Paragraph H: A method as any of Paragraphs E-G recite, wherein a particular program of the plurality of programs has an associated particular program source, the particular program source being a limited access program source.

Paragraph I: A method as any of Paragraphs E-H recite, wherein determining the lineup for the custom channel comprises receiving an assignment of a presentation time to a particular program of the plurality of programs.

Paragraph J: A method as any of Paragraphs E-I recite, wherein determining the lineup for the custom channel comprises: identifying a particular program of the plurality of programs, the particular program having associated therewith a broadcast program source; identifying a lineup date and time as a date and time at which the particular program is scheduled to be broadcast via the broadcast program source; and automatically assigning the lineup date and time to the particular program in the lineup for the custom channel.

Paragraph K: A method as any of Paragraphs E-J recite, further comprising: receiving a request to display an electronic program guide; accessing a first set of program metadata associated with commercially available channels; accessing a second set of program metadata associated with one or more custom channels; and presenting an electronic program guide that includes the first set of program metadata and the second set of program metadata.

Paragraph L: A method as any of Paragraphs E-K recite, further comprising: receiving a request to access programming via the custom channel; and in response to receiving the request to access the programming via the custom channel: determining a current program in the lineup based, at least in part, on a current time; determining a program source associated with the current program; and accessing the program source associated with the current program to present the current program.

Paragraph M: A method as Paragraph L recites, wherein determining the current program in the lineup is further based on a current date.

Paragraph N: A method as Paragraph L or Paragraph M recites, wherein accessing the program source associated with the current program comprises: determining that the program source is a limited access program source; identifying user credentials to access the limited access program source; and submitting the user credentials to the limited access program source.

Paragraph O: A method as Paragraph N recites, wherein identifying user credentials to access the limited access program source comprises launching a login website associated with the limited access program source.

Paragraph P: A method as any of Paragraphs E-O recite, further comprising publishing the custom channel to make the custom channel available to other users.

Paragraph Q: A method as any of Paragraphs E-P recite, further comprising: receiving, in association with a user profile, a request to delete the custom channel; and disassociating the custom channel with the user profile, such that the custom channel is no longer viewable via the user profile.

Paragraph R: A method as Paragraph Q recites, further comprising: determining that the custom channel was created in association with the user profile; identifying any number of other user profiles that are subscribed to the custom channel; unsubscribing the other user profiles from the custom channel; and deleting the custom channel.

Paragraph S: One or more computer-readable media comprising computer-executable instructions that, when executed on a processor, direct a computing device to perform operations comprising: receiving a request to view a list of available custom channels; in response to receiving the request to view the list of available custom channels: retrieving data identifying published custom channels; and presenting a list of available custom channels; receiving a selection of a custom channel from the list of available custom channels; associating the selected custom channel with a user profile to facilitate future access to the custom channel through the user profile; receiving a request to display an electronic program guide; and in response to receiving the request to display the electronic program guide: accessing a first set of program metadata associated with commercially available channels; accessing a second set of program metadata identifying one or more custom channels associated with a current user profile; and presenting an electronic program guide that includes the first set of program metadata and the second set of program metadata.

Paragraph T: One or more computer-readable media as Paragraph S recites, wherein the second set of program metadata identifies at least one of: a custom channel created in association with the user profile; or a custom channel created in association with another user profile.

### CONCLUSION

Although a custom media channel system has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more client device(s) 104 or server computer system 502, such as one or more internal or external CPUs or GPUs, and/or one or more pieces of hardware logic such as FPGAs, DSPs, or other types of accelerators.

The methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

We claim:

1. A custom channel device comprising:
a processor;
a memory;
a user interface stored in the memory and executed on the processor to enable creation of a custom channel comprising a plurality of programs;
a custom channel data store for maintaining:
program data associated with the plurality of programs of the custom channel; and
a lineup that associates a particular date and time with a particular program such that when the custom channel is accessed at the particular date and time, the particular program is presented; and
a custom channel access module stored in the memory and executed on the processor to facilitate access to respective program sources associated with the plurality of programs.

2. A custom channel device as recited in claim 1, wherein:
a first program of the plurality of programs has associated therewith a first program source;
a second program of the plurality of programs has associated therewith a second program source;
the first program source is different from the second program source;
the custom channel access module accesses the first program source at a date and time associated with the first program in the lineup; and
the custom channel access module accesses the second program source at a date and time associated with the second program in the lineup.

3. A custom channel device as recited in claim 1, further comprising a custom channel selections data store to maintain a list of custom channels accessible through a particular profile.

4. A custom channel device as recited in claim 3, wherein the list of custom channels accessible through the particular profile comprises:
a custom channel created in association with the particular profile; and
a custom channel created and published in association with another profile.

5. A method comprising:
receiving a request to create a custom channel;
in response to the receiving:
determining a plurality of programs to include in the custom channel, each program of the plurality of programs having a respective program source such that:
a first program of the plurality of programs is associated with a first program source;
a second program of the plurality of programs is associated with a second program source; and
the second program source is different from the first program source; and
determining a lineup for the custom channel that specifies, for individual ones of the plurality of programs, a presentation time.

6. A method as recited in claim 5, wherein:
a first program of the plurality of programs comprises commercially produced media content; and
a second program of the plurality of programs comprises user-created media content.

7. A method as recited in claim 5, wherein determining a plurality of programs to include in the custom channel comprises receiving an indication of a particular program to include in the custom channel.

8. A method as recited in claim 5, wherein a particular program of the plurality of programs has an associated particular program source, the particular program source being a limited access program source.

9. A method as recited in claim 5, wherein determining the lineup for the custom channel comprises receiving an assignment of a presentation time to a particular program of the plurality of programs.

10. A method as recited in claim 5, wherein determining the lineup for the custom channel comprises:
identifying a particular program of the plurality of programs, the particular program having associated therewith a broadcast program source;
identifying a lineup date and time as a date and time at which the particular program is scheduled to be broadcast via the broadcast program source; and
automatically assigning the lineup date and time to the particular program in the lineup for the custom channel.

11. A method as recited in claim 5, further comprising:
receiving a request to display an electronic program guide;
accessing a first set of program metadata associated with commercially available channels;
accessing a second set of program metadata associated with one or more custom channels; and
presenting an electronic program guide that includes the first set of program metadata and the second set of program metadata.

12. A method as recited in claim 5, further comprising:
receiving a request to access programming via the custom channel; and
in response to receiving the request to access the programming via the custom channel:
determining a current program in the lineup based, at least in part, on a current time;
determining a program source associated with the current program; and
accessing the program source associated with the current program to present the current program.

13. A method as recited in claim 12, wherein determining the current program in the lineup is further based on a current date.

14. A method as recited in claim 12, wherein accessing the program source associated with the current program comprises:
determining that the program source is a limited access program source;
identifying user credentials to access the limited access program source; and
submitting the user credentials to the limited access program source.

15. A method as recited in claim 14, wherein identifying user credentials to access the limited access program source comprises launching a login website associated with the limited access program source.

16. A method as recited in claim 5, further comprising publishing the custom channel to make the custom channel available to other users.

17. A method as recited in claim 5, further comprising:
receiving, in association with a user profile, a request to delete the custom channel; and
disassociating the custom channel with the user profile, such that the custom channel is no longer viewable via the user profile.

18. A method as recited in claim 17, further comprising:
determining that the custom channel was created in association with the user profile;
identifying any number of other user profiles that are subscribed to the custom channel;
unsubscribing the other user profiles from the custom channel; and
deleting the custom channel.

19. One or more computer-readable media comprising computer-executable instructions that, when executed on a processor, direct a computing device to perform operations comprising:
receiving a request to view a list of available custom channels;
in response to receiving the request to view the list of available custom channels:
retrieving data identifying published custom channels; and
presenting a list of available custom channels;
receiving a selection of a custom channel from the list of available custom channels;
associating the selected custom channel with a user profile to facilitate future access to the custom channel through the user profile;
receiving a request to display an electronic program guide; and
in response to receiving the request to display the electronic program guide:
accessing a first set of program metadata associated with commercially available channels;
accessing a second set of program metadata identifying one or more custom channels associated with a current user profile; and
presenting an electronic program guide that includes the first set of program metadata and the second set of program metadata.

20. One or more computer-readable media as recited in claim 19, wherein the second set of program metadata identifies at least one of:
a custom channel created in association with the user profile; or
a custom channel created in association with another user profile.
